(19) United States
(12) Patent Application Publication
(10) Pub. No.: US 2011/0107056 A1
(43) Pub. Date: May 5, 2011

(54) METHOD FOR DETERMINING DATA CORRELATION AND A DATA PROCESSING METHOD FOR A MEMORY

(75) Inventor: Tei-Wei Kuo, Taipei City (TW)

(73) Assignee: ACER INCORPORATED, Taipei Hsien (TW)

(21) Appl. No.: 12/890,202

(22) Filed: Sep. 24, 2010

(30) Foreign Application Priority Data
Oct. 29, 2009 (TW) 98136626

(51) Int. Cl. G06F 12/10

(52) U.S. Cl. 711/203; 711/E12.061

(57) ABSTRACT

A method for determining data correlation and a data processing method for a memory are disclosed. The data with correlation is collected and stored in the same block. Also the data with correlation is determined based on a specific function to be executed by the user. In other words, if the user needs to access some data in order to perform the specific function, those data has correlation.

### CROSS-REFERENCE TO RELATED APPLICATIONS

This application claims the right of priority based on Taiwan Patent Application No. 98136626, entitled “METHOD FOR DETERMINING DATA CORRELATION AND DATA PROCESSING METHOD FOR A MEMORY,” filed on Oct. 29, 2009, which is incorporated herein by reference and assigned to the assignee herein.

### TECHNICAL FIELD

The present invention relates to a method for determining data correlation and a data processing method for a memory, and particularly to a method of determining a correlation between sequentially accessed data and a data processing method for a memory.

### BACKGROUND OF THE INVENTION

The characteristic of a flash memory is that it cannot be directly overwritten, and has limited times of erasing. Incapable of being directly overwritten means that, before the new data is stored, if the corresponding blocks of the flash memory already have written data, the new data can be stored only after the previously written data are erased. Moreover, the processing time for erasing data in a memory is longer than that of data reading or writing, so that the access performance of a memory can be improved by reducing the times of data erasing.

The flash memory also has the limitation on times of erasing. If the memory is frequently undergone with erasing process for data access, the lifespan of the memory will be reduced. In the prior art, in order to reduce the times of data moving and erasing, the data is classified as cold data and hot data by dynamically analyzing the attribute of data. The so-called cold data and hot data respectively indicate the less accessed data and the more frequently accessed data within a unit time. The prior art generally teaches storing the cold data in the same block, and the hot data in another block, so that the cold and hot data can be processed respectively to improve the access efficiency, and reduce the required times of erasing. However, classifying data as cold or hot based on the access frequency still has its defect. Therefore, it is necessary to provide a new data processing method for a memory and a determining method.

### SUMMARY OF INVENTION

One object of the present invention is to provide a data processing method for a memory. The method is to store the data with correlation in the same block, so that there is no need to access multiple blocks when accessing data; in which, the data with correlation are a plurality of data accessed in turn based on specific rules, or a plurality of data sequentially accessed for performing specific functions.

Another object of the present invention is to provide a method for determining data correlation, wherein the data with correlation means a plurality of data sequentially accessed by a user for performing specific functions, so that the plurality of data are applied for performing said specific functions.

One aspect of the present invention is a data processing method for a memory, wherein the memory comprises a plurality of blocks, and each block has a plurality of pages. The data processing method comprising:

(a) finding the data blocks having data written from the plurality of blocks;

(b) classifying multiple sequentially accessed pages from the plurality of pages in at least one data block as at least one page group; and

(c) copying multiple pages of at least one page group into blank blocks without data written among a plurality of blocks.

Another aspect of the present invention is a method of determining a correlation between a plurality of sequentially accessed data, wherein each of said data respectively corresponding to a different one of a plurality of logic block addresses in a memory, said method comprising the steps of:

(a) computing a first logic block address corresponding to a first one of said data by a function to output a first value;

(b) computing a second logic block address corresponding to a second one of said data by said function to output a second value, said second one of said data being accessed after said first one of said data;

(c) adding a third value to a correlation parameter corresponding to said first value and said second value to obtain an accumulated correlation parameter; and

(d) if said accumulated correlation parameter is larger than a threshold value, determining said correlation is existing between said first one of said data and said second one of said data.

### BRIEF DESCRIPTION OF DRAWINGS

FIG. 1 shows a diagram between physical block address and logic block address in a conventional memory;

FIG. 2 shows a flowchart of an embodiment for the memory data processing method according to the present invention;

FIG. 3 shows a diagram of a memory applying said data processing method;

FIG. 4 shows a flowchart for the method of determining data correlation according to the present invention; and

FIG. 5a and FIG. 5b show the diagrams for the method of determining data correlation that applies the present invention.

### DETAILED DESCRIPTION OF PREFERRED EMBODIMENTS

Since the prior art classified the data as cold data and hot data, it may be possible that a plurality of data having data correlation are stored in different blocks, so as to deteriorate the data access efficiency of a memory. The present invention provides a method of determining data correlation and a data processing method for a memory. An embodiment of the present invention can determine the data having sequentially accessed correlation, and store the data with correlation in the same or nearby blocks in a memory so as to enhance the data access efficiency.

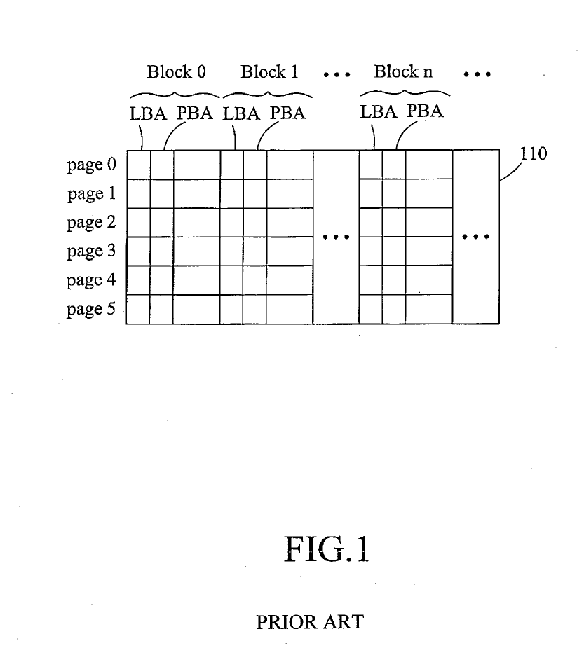

FIG. 1 shows a diagram of physical block address and logic block address in a conventional memory. As shown in FIG. 1, the memory 110 comprises multiple blocks, and each block comprises multiple pages for data storage, and each page has a corresponding physical block address (PBA), and each physical block address is also corresponding to a logical block address (LBA). The sequential physical block addresses (PBA) may not be corresponding to sequential logic block addresses. The data access process of an external system (not shown) is first to send a logic block address to a control unit (not shown) of the memory 110; then, the control unit finds the physical block address corresponding to the logic block address in the memory 110; finally, the control unit accesses the data at the physical block address, and send to the external system.

As previously described, in the prior art, in order to enhance the access efficiency of a memory, the data will be classified as cold data and hot data according to the times of access within the unit time, and the hot data will be stored in the same block, while the cold data will be stored in another block, wherein the hot data is more frequently accessed, and the cold data is less accessed. However, a plurality of hot data in the same block may not have the correlation to each other indicated in the present invention. Thus, when the user needs to access a plurality of hot data classified by the prior art for performing specific functions, he might need to access said hot data in different blocks and result in the deterioration of access efficiency.

In view of above issue, the present invention provides a data processing method for a memory. The method is to store the data with sequentially accessed correlation in the same block, so there is no need to individually access said data in multiple blocks. In this embodiment, the data with sequentially accessed correlation means a plurality of data accessed by a user for performing specific functions. In other words, the plurality of data is applied for performing said specific functions. For example, for performing computer boot-up by the user, the data with sequentially accessed correlation comprises BIOS code, disk boot-up code, operating system startup code, etc. Thus, the BIOS code, the disk boot-up code and the operating system startup code are the data with sequentially accessed correlation. Also, for example, when the user wants to look for a folder and a file on the storage device, the data with sequentially accessed correlation comprise the data of folder name, the data of sub-folder name, and the data of file name, etc. Moreover, the sequential access means the data is sequentially accessed based on the sequence of the step for performing a specific function, but not limited to sequential access in time.

One embodiment of the present invention provides two methods for determining the data with sequentially accessed correlation. One method employs the characteristic of a memory for sequentially writing data regularly based on the sequence of logic block address for determining. The other method employs a statistic method to determine if the sequentially accessed correlation is existing between data.

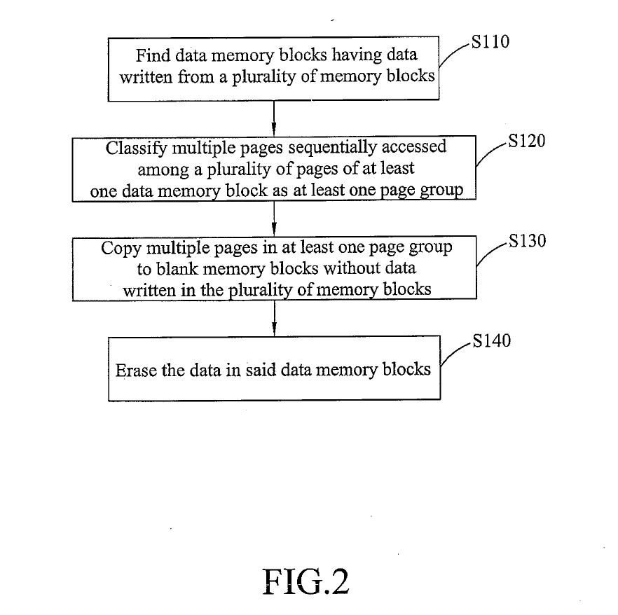

FIG. 2 shows a flowchart of an embodiment for a data processing method for a memory according to the present invention. The method is applied for a data processing method for a memory. The memory in this embodiment is a flash memory. The flash memory comprises a plurality of blocks, and each block has a plurality of pages, and each page also has corresponding logic block address and physical block address. First, the method is to find the data block having data written in the plurality of blocks (S110). To avoid consuming too much time for finding data blocks having data written, the embodiment can be configured for performing the next step once finding a specific number of data blocks, for example at least one.

Next, for a plurality of pages in at least one data block, the method is to classify multiple pages determined for sequentially accessed as at least one page group (S120). In this embodiment, the method for determining multiple pages being sequentially accessed employs the characteristic of a memory for sequentially writing data regularly based on the sequence of logic block address for determining the data stored in the sequential logic block address as having sequentially accessed correlation. Thus, the method is first to record the logic block addresses of a plurality of pages in at least one data block; then, classifying multiple pages with nearby logic block addresses in the plurality of pages as at least one page group; wherein, the nearby logic block addresses mean that the value difference between logic block addresses is within a specific range, for example, the value difference is less than 3. In another embodiment, the nearby logic block addresses mean the values of logic block addresses are sequential, for example, the logic block addresses of multiple pages are 1, 2 and 3.

After the multiple pages determined as sequentially accessed are classified as at least one page group, the multiple pages in the page group are copied to blank blocks without data written in the plurality of blocks (S130). In order for the multiple pages in the same page group to be rapidly accessed, these pages are written into the same blank block. Also, in order to be compliant with the characteristic of flash memory for data writing based on the sequence of logic block addresses, the multiple pages classified to the same page group are written into the same block memory based on the sequence of logic block addresses.

Furthermore, the embodiment can selectively comprise erasing data in the above-mentioned data block (S140), so making these data blocks as blank blocks provides the subsequent data storage. The above-mentioned data processing method for a memory may be manually enabled by a user, or the flash memory will perform this method at a specific time interval.

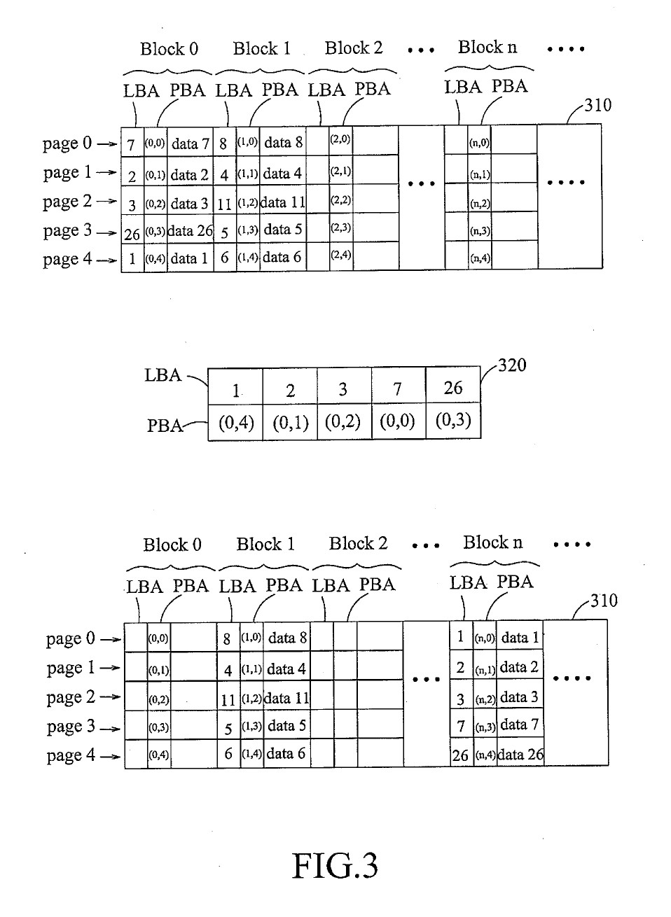

FIG. 3 shows a diagram of a memory applying this data processing method. As shown in the diagram, a flash memory 310 comprises a lot of blocks, such as block 0, block 1, block 2, block n and other blocks, and each block comprises multiple pages, such as page 0, page 1, page 2, page 3 and page 4. As shown in the upper half of FIG. 3, the blocks, block 0 and block 1 in the flash memory 310 are the data blocks having data written, and the blocks, block 2 and block n, are the blank blocks without data written. When the flash memory 310 performs this data processing method, it first finds the data blocks for a specific number of ones having data written according to the step (S110). In this example, it is configured to perform the next step after finding a data block having data written, such as the data block, block 0.

Next, based on the step (S120), the method classifies multiple pages determined as sequentially accesses in the data block, block 0, as at least one page group 320. One characteristic for sequentially accessed pages is that these pages have continuous sequence of logic block addresses. The reason of creating such a characteristic is that the memory in general, will write data continuously based on the sequence of logic block addresses. Thus, the step (S120) will first record the logic block addresses 7, 2, 3, 26 and 1 on all pages, page 0, page 1, page 2, page 3 and page 4 in the data memory block 0; then, multiple pages with nearby logic block addresses on said pages, page 0, page 1, page 2, page 3 and page 4 will be classified to a page group 320. Particularly, the information (including logic block address and physical block address) on multiple pages, page 4, page 1 and page 2 with sequential logic block addresses 1, 2, and 3 are recorded in the page group 320 based on the sequence of logic block addresses, and arranging the information on remaining pages, page 0 and page 3, thereafter. The step (S120) is mainly to record the information on multiple pages with sequential logic block addresses based on the sequence of logic block addresses in the same page group. Thus, in another embodiment, the method may store the information on pages with non-sequential logic block addresses, such as page 3 and page 4, in another page group.

Finally, the step (S130) copies the data on each page based on the sequence of logic block addresses to a page of a blank block according to the information on multiple pages recorded in the page group 320. The blank block is a block without data written. In this example, the method selects a blank block n, as the new data block for data storage, as shown in the lower half of FIG. 3. The step (S130) copies the corresponding data, data 1, data 2, data 3, data 7 and data 26, to the pages, page 0, page 1, page 2, page 3 and page 4, of a new data block, block n, according to the sequence of the logic block addresses, 1, 2, 3, 7, 26, of each page stored in the page group 320. The step (S130) is mainly to store the data on multiple pages with sequential logic block addresses in the same block. Thus, in another embodiment, the method may store the data on pages with non-sequential logic block addresses, such as page 3 and page 4, in another block. Moreover, because the data in the data block 0, has been further stored in the data block n, according to an embodiment of the method, the method will erase the data in the data block 0, and make it as a new blank block based on the step (S140).

The above description discloses a memory data processing method provided by the present invention. The method is to store the data with sequentially accessed correlation in the same or nearby blocks. The above-mentioned embodiment is only recorded with the process for one data block. One skilled in the art should understand that if multiple data blocks can be processed simultaneously, the data with correlation can be further stored in the same or nearby blocks to enhance the access efficiency. Moreover, the above context also describes a method of determining data with sequentially accessed correlation. The determining method employs the characteristic of a memory for sequentially writing data regularly based on the sequence of logic block address for determining the data in the sequential logic block address as having sequentially accessed correlation. Furthermore, an embodiment of the present invention also provides another determining method, which employs a statistic method for determining if the sequentially accessed correlation exists between data.

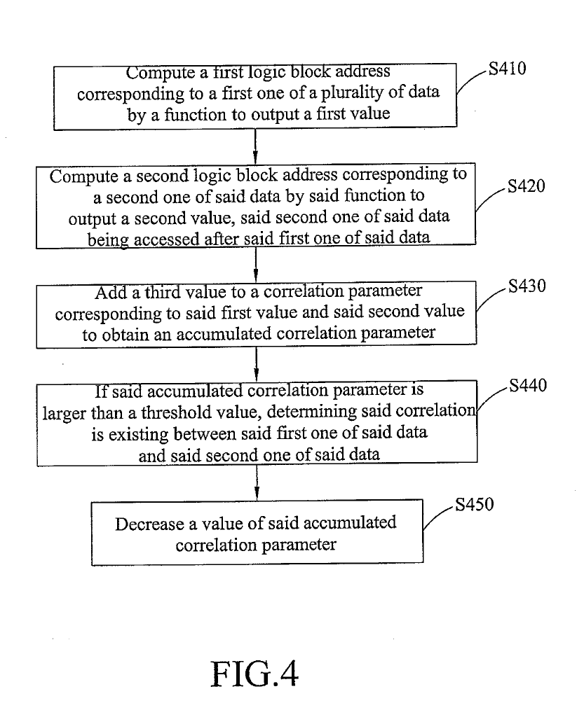

FIG. 4 shows a flowchart for the method of determining data correlation provided in the embodiment of the present invention, which employs a statistic method to determine the data with sequentially accessed correlation. Each of a plurality of data is corresponding to one logic block address in a memory. First, when at least one of the plurality of data is initially accessed, the method computes a logic block address corresponding to the data by a function to output a first value (S410), wherein each logic block address is a value. In an embodiment, the method will compute the logic block addresses of firstly accessed several data based on the sequence of data access by the function to output the individually corresponding first values. Moreover, the function may be a Hash function, a Remainder function or other functions.

Next, the method computes a logic block address corresponding to at least another one data being accessed after the at least one of the plurality of data by the same function to output a second value (S420). In the step (S420), the at least another one data is the data sequentially accessed after the at least one data, so both of them may be the data sequentially accessed by an user for performing specific functions, but which still needs further determination. Then, the method adds a third value to a correlation parameter corresponding to the first and second values (S430), wherein the correlation parameter corresponding to the first and second values are used to evaluate if the at least one data and the at least another one data are sequentially accessed on a frequent basis. Thus, when occurring sequential access, the correlation parameter will be added with the third value, such as value “1”.

Finally, the method compares the correlation parameter with a threshold value. If the correlation parameter is larger than the threshold value, it can be determined that the correlation of sequentially accessed data is existing between the at least one data and the at least another one data (S440). In addition, the determining method may selectively include the step (S450) to decrease the value of correlation parameter. The purpose is to reduce the influence of a user on the current determination due to the previous data access behavior of the user. The method for decreasing value of correlation parameter, for example, may be subtracting the value of the correlation parameter by a fourth value, or may dividing the correlation parameter by a fifth value. The above step (S450) may be manually enabled by a user, or be performed at a specific time interval.

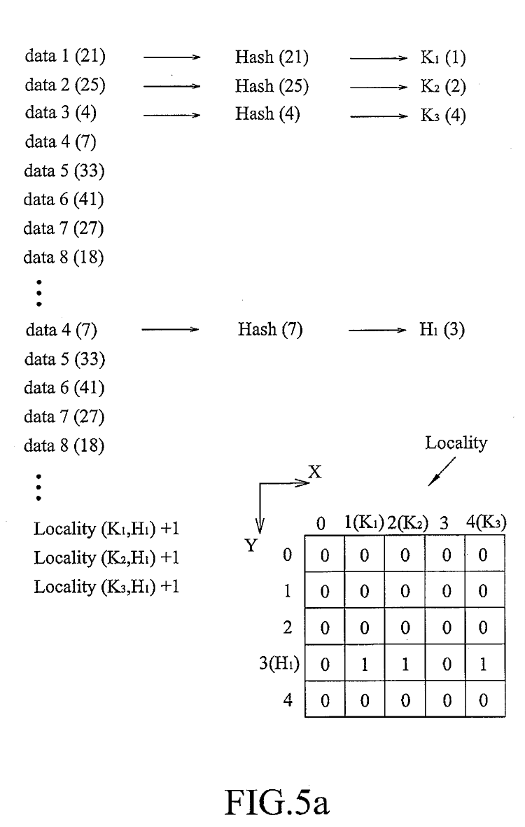

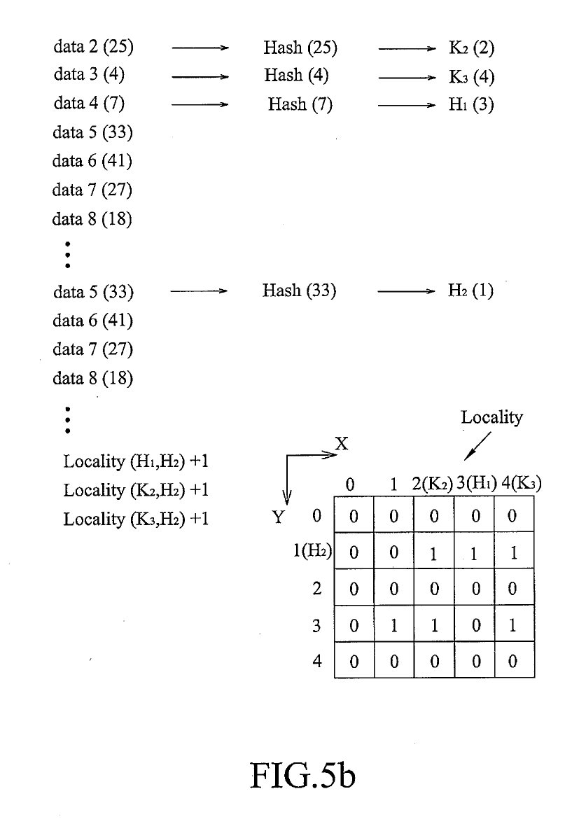

FIG. 5a and FIG. 5b show the diagrams for the method of determining data correlation applying the present invention. As shown in FIG. 5a, in the step (S410), if multiple data are sequentially accessed, in order to determine if the correlation of sequentially accessed data is existing between said data, the method is first to compute the values of at least one data which is accessed at earliest, such as values 21, 25, 4 of logic block addresses for three data accessed at earliest, data 1, data 2 and data 3, by a function Hash based on the access sequence and output three corresponding first values, K1=1, K2=2 and K3=4. Next, based on the step (S420), the method computes the logic block addresses of the at least another data accessed after the three data, data 1, data 2 and data 3, such as value 7 of the logic block address for data 4, by the same function Hash to output a corresponding second value, H1=3. Then, the step (S430) individually adds a third value to the correlation parameters, Locality(K1, H1), Locality(K2, H1) and Locality(K3, H1) corresponding to said first and second values. The third value in this embodiment is “1”. To facilitate the recording of multiple correlation parameters, the embodiment employs a correlation parameter table Locality for recording multiple correlation parameters, such as K1=1, H1=3, so that the value of Locality(K1, H1) will be recorded in the field of the correlation parameter table Locality with X coordinate as “1” and Y coordinate as “3”. Subsequently, the step (S440) compares each correlation parameter Locality(K1, H1), Locality(K2, H1) and Locality(K3, H1) with a threshold value. For example, the threshold value is configured as 100. If the value of correlation parameter is larger than 100, it can be determined that the correlation of sequentially accessed data is existing between the two data corresponding to the correlation parameter. For example, if the value of correlation parameter Locality(K1, H1) is larger than 100, it indicates the correlation of sequentially accessed data is existing between data 1 of logic block address 21 corresponding to K1 and data 4 of logic block address 7 corresponding to H1. Moreover, the step (S440) performs an inverse function on the values, K1=1 and H1=3, to obtain the corresponding logic block addresses 21 and 7, and the inverse function is corresponding to the above-mentioned function.

One skilled in the art can understand that when multiple data are accessed, the steps (S410) to (S440) can be repetitively performed to evaluate the sequentially accessed correlation between the next accessed data and the previous data. As shown in FIG. 5b, if the next data, data 5, is going to be accessed, the method first computes the first values for the first three data based on the step (S410), wherein the values 25, 4, 7 of the logic block addresses of data 2, data 3 and data 4 will be computed by the function Hash based on the accessed sequence to output three corresponding first values, K2=2, K3=4 and H1=3; or, just replacing the first value K1 outputted after computing the logic block address 21 of data 1 by the function with the first value H1 outputted after computing the logic block address 7 of data 4. Then, the step (S420) computes the logic block address 33 of data 5 accessed after the three data, data 2, data 3 and data 4 by the same function to output a corresponding second value, H2=1.

The step (S430) adds a third value “1” to the correlation parameters Locality(H1, H2), Locality(K2, H2) and Locality(K3, H2) corresponding to said first values and second values. Finally, the step (S440) compares each correlation parameter Locality(H1, H2), Locality(K2, H2) and Locality(K3, H2) with a threshold value. If the value of the correlation parameter is larger than the threshold value, it can be determined that the correlation of sequentially accessed data is existing between the two data corresponding to the correlation parameter. The above description is only a preferred embodiment of the present invention, and not intended to limit the implementation of the present invention. For example, other specific number of data can be selected to obtain the first value, or other specific number of data can be selected to obtain the second value. Moreover, other methods can be employed to gather statistics to determine if sequentially accessed correlation is existing between data, but not limited to gather statistics for data correlation by using correlation parameter and establishing a correlation parameter table. The preferred embodiments of the present invention described above disclose two determining methods to determine the data with sequentially accessed correlation, but other determining methods also belong to the claims of the present invention; wherein, the data with sequentially accessed correlation means a plurality of data accessed by a user for performing specific functions.

The above-mentioned are only the preferred embodiments of the present invention, but not limiting the claims of the present invention; all the equivalent variations or modifications, without departing from the spirit disclosed by the present invention, should be construed as falling within the scope of the following claims.

We claim:

1. A method of determining a correlation between a plurality of sequentially accessed data, wherein each of said data respectively corresponding to a different one of a plurality of logic block addresses in a memory, said method comprising the steps of:
(a) computing a first logic block address corresponding to a first one of said data by a function to output a first value;
(b) computing a second logic block address corresponding to a second one of said data by said function to output a second value, said second one of said data being accessed after said first one of said data;
(c) adding a third value to a correlation parameter corresponding to said first value and said second value to obtain an accumulated correlation parameter; and
(d) if said accumulated correlation parameter is larger than a threshold value, determining said correlation is existing between said first one of said data and said second one of said data.

2. The method according to claim 1, wherein said function is a Hash function.

3. The method according to claim 1, wherein said function is a Remainder function.

4. The method according to claim 1, wherein said step (d) further comprises performing an inverse function corresponding to said function on said first value and said second value, so as to determine said first logic block address corresponding to said first value and said second logic block address corresponding to said second value.

5. The method according to claim 1, further comprising the step of:
(e) decreasing a value of said accumulated correlation parameter.

6. The method according to claim 5, wherein said step (e) is performed by subtracting said value of said accumulated correlation parameter by a fourth value.

7. The method according to claim 5, wherein said step (e) is performed by dividing said value of said accumulated correlation parameter by a fifth value.

8. The method according to claim 5, wherein said step (e) is manually enabled by a user.

9. The method according to claim 5, wherein said step (e) is performed every specific time interval.

10. A method of determining a correlation between a plurality of sequentially accessed data, wherein each of said data respectively corresponding to a different one of a plurality of logic block addresses in a memory, said method comprising the steps of:
(a) computing a first logic block address corresponding to a first one of said data by a function to output a first value;
(b) computing a second logic block address corresponding to a second one of said data by said function to output a second value, said second one of said data being accessed after said first one of said data;
(c) adding a third value to a correlation parameter corresponding to said first value and said second value to obtain an accumulated correlation parameter;
(d) if said accumulated correlation parameter is larger than a threshold value, performing an inverse function corresponding to said function on said first value and said second value, so as to determine said first logic block address corresponding to said first value and said second logic block address corresponding to said second value; and
(e) decreasing a value of said accumulated correlation parameter every specific time interval;
wherein if said accumulated correlation parameter is larger than said threshold value, determining said correlation is existing between said first one of said data and said second one of said data.

11. The method according to claim 10, wherein said function is a Hash function.

12. The method according to claim 10, wherein said function is a Remainder function.

13. The method according to claim 10, wherein said step (e) is performed by subtracting said value of said accumulated correlation parameter by a fourth value.

14. The method according to claim 10, wherein said step (e) is performed by dividing said value of said accumulated correlation parameter by a fifth value.
